(19) United States
(12) Patent Application Publication
(10) Pub. No.: US 2007/0071387 A1
(43) Pub. Date: Mar. 29, 2007

(54) Optical fiber array device

(76) Inventor: Allen Weng, Lujhu Township (TW)

Correspondence Address: HDSL, 4331 STEVENS BATTLE LANE, FAIRFAX, VA, 22033, US

(21) Appl. No.: 11/233,013

(22) Filed: Sep. 23, 2005

(51) Int. Cl. G02B 6/32; G02B 6/04

(52) U.S. Cl. 385/33; 385/115; 385/120; 385/31

(57) ABSTRACT

An optical fiber array device includes a substrate provided with a plurality of accommodating regions and a plurality of optical fibers each provided in the accommodating region of the substrate. One end of the accommodating region is provided with an opening communicating with the other surface of the substrate, and the other end of the accommodating region is provided with a light-focusing element in the substrate. The light-emitting face of each optical fiber corresponds to the light-focusing element of each accommodating region. With this structure, the optical fibers can be easily positioned on the substrate, and the light-focusing elements are used to produce better effects in light focusing and illuminating.

### BACKGROUND OF THE INVENTION

1. Field of the Invention

The present invention relates to an optical fiber array device, and more particularly, to a device in which optical fibers can be easily positioned to produce better effects in light focusing and illuminating of a light source.

2. Description of Prior Art

With reference to FIG. 1, a conventional optical fiber array structure mainly comprises a substrate 3 provided with at least one through hole 31 penetrating the substrate 3. Each through hole 31 is provided with an optical fiber 4 therein. The light-emitting face 41 of each optical fiber 4 corresponds to an opening at the other end of the through hole 31, such that the light-emitting face 41 of the optical fiber forms a larger light source face in the substrate 3.

In the above conventional optical fiber array structure, although each optical fiber 4 can pass through the substrate and the light-emitting face 41 of the optical fiber 4 can be used to form a larger light source face in the substrate 3, the optical fiber 4 may penetrate through the other end of the through hole 31 when the optical fiber 4 is inserted into the through hole of the substrate, which may result in the difficulty in assembling. Further, when the light source is guided by the optical fiber 4 to the outside, the light source may be directly emitted out via the light-emitting face 41 of the optical fiber 4 and the through hole 31. As a result, the light source cannot be guided onto the substrate 3 to uniformly distributed on the surface of the substrate 3. Accordingly, the conventional optical fiber array structure cannot conform to the demands of actual utilization.

### SUMMARY OF THE INVENTION

The object of the present invention is to overcome the above drawbacks. The present invention redesigns the substrate, such that each hole (accommodating region) for inserting the optical fiber does not penetrate the substrate. Therefore, the optical fiber can be easily assembled on the substrate, and can efficiently guide the light source onto the substrate. Accordingly, the light source on the substrate can be uniformly distributed and produce an excellent illumination.

In order to achieve the above objects, the present invention provides an optical fiber array structure, which comprises a substrate provided with a plurality of accommodating regions and a plurality of optical fibers each provided in the accommodating region. One end of each accommodating region is provided with an opening communicating with one surface of the substrate. A light-focusing element is provided in one end of the accommodating region. Further, the light-emitting face of each optical fiber corresponds to the light-focusing element in each accommodating region.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a cross sectional view of a conventional art;

FIG. 2 is a cross sectional view of the first embodiment of the present invention;

FIG. 3 is a cross sectional view of the second embodiment of the present invention;

FIG. 4 is a perspective view of the present invention;

FIG. 5 is a perspective view of the other embodiment of the present invention;

FIG. 6 is a cross sectional view of the third embodiment of the present invention;

FIG. 7 is a cross sectional view showing the state of light focusing and refracting of the present invention;

FIG. 8 is a cross sectional view of the fourth embodiment of the present invention;

FIG. 9 is a cross sectional view of the fifth embodiment of the present invention;

FIG. 10 is a cross sectional view of the sixth embodiment of the present invention;

FIG. 11 is a cross sectional view of the seventh embodiment of the present invention; and

FIG. 12 is a perspective view of the eighth embodiment of the present invention.

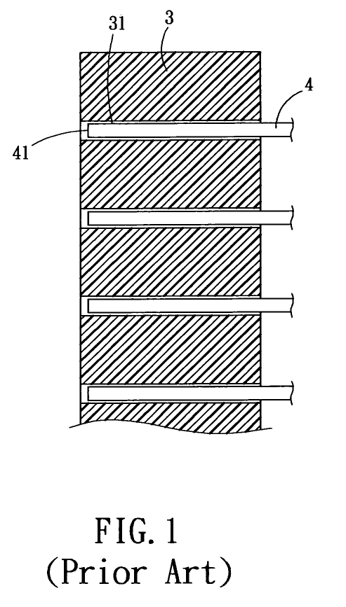

### DETAILED DESCRIPTION OF THE INVENTION

Herein, the technical contents and detailed description of the present invention will be explained with reference to the drawings.

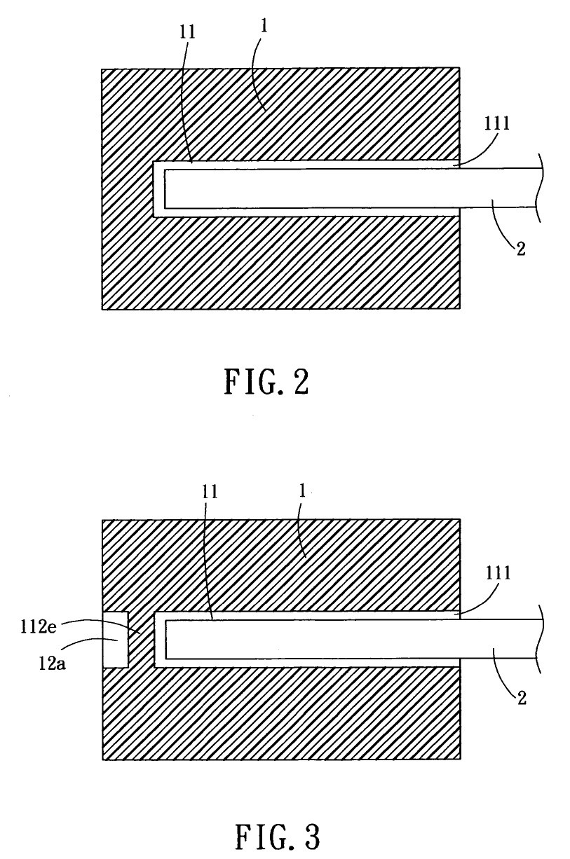

With reference to FIG. 2 and FIG. 3, a cross sectional view of the first embodiment and a cross sectional view of the second embodiment of the present invention are shown. The present invention is an optical fiber array device comprising a substrate 1 made of a transparent material. The substrate 1 is provided with a plurality of accommodating regions 11. One end of each accommodating region 11 is provided with an opening 111 communicating with the other surface of the substrate 1.

When in use, each optical fiber 2 can be inserted from the opening 111 of the accommodating region 11, such that the optical fiber 2 can be easily positioned on the substrate 1. Also, a plane-like groove 12a is provided on the surface of the substrate 1 to correspond to the accommodating region 11.

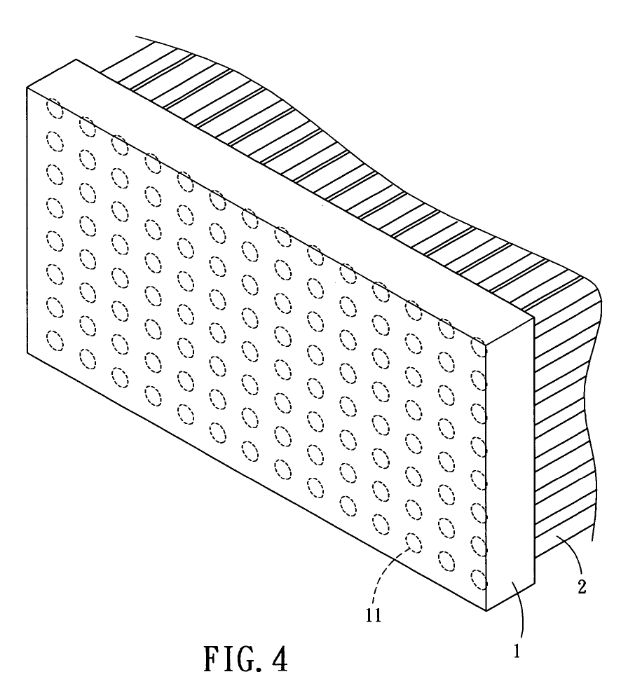

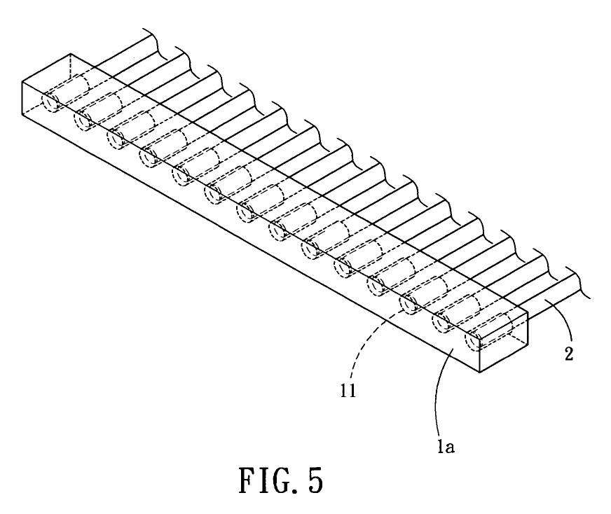

With reference to FIG. 4 and FIG. 5, a perspective view of the present invention and a perspective view of the other embodiment of the present invention are shown. Each accommodating region 11 of the substrate 1 can be arranged as an array (as shown in FIG. 4) or a row (as shown in FIG. 5), such that each optical fiber 2 can be arranged in a various manner.

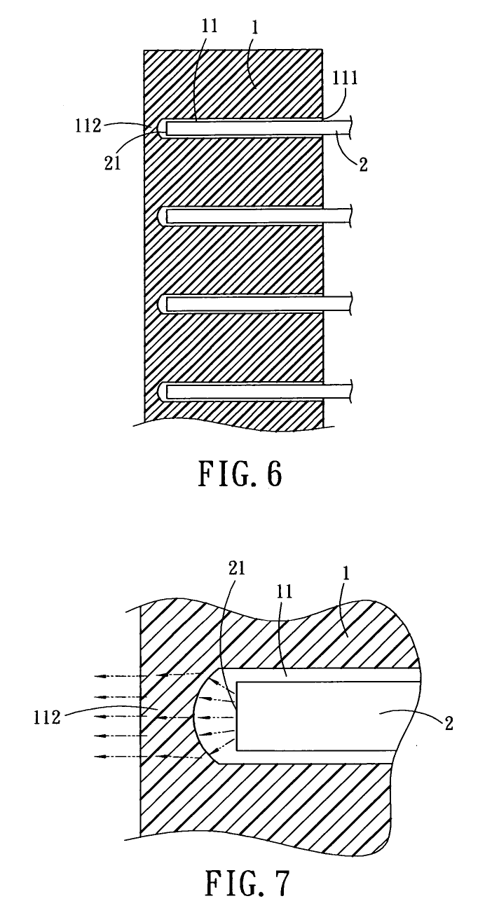

With reference to FIG. 6, a cross sectional view of the first embodiment of the present invention is shown. The present invention is an optical fiber array device comprising a substrate 1 and a plurality of optical fibers 2, in which the optical fiber can be easily positioned on the substrate and the light-focusing elements are used to produce better effects in light focusing and illuminating.

The above substrate 1 is made by a transparent material, and provided with a plurality of accommodating region 11. One end of each accommodating region 11 is provided with an opening 111 communicating with the other surface of the substrate 1. The other end of the accommodating region 11 is provided with a light-focusing element 112 in the substrate 1. The light-focusing element 112 can be an outward-projecting lens.

Each optical fiber 2 can be directly inserted from the opening 111 in the accommodating region 11, such that the optical fiber 2 can be easily positioned in the accommodating region 11 of the substrate 1. Also, the light-emitting face 21 of each optical fiber 2 corresponds to the light-emitting element 112 in each accommodating region 11.

With reference to FIG. 7, a cross sectional view showing the state of light focusing and refracting of the present invention is shown. During the operation, of the present invention, a light source (not shown) can be applied to one end of each optical fiber 2, such that the light emitted by the light source can be emitted from the light-emitting face 21 of each optical fiber 2. The light emitted from each optical fiber 2 can be focused by the light-focusing element 112 provided on one end of the accommodating region 11, and thus emitted from the end face of the substrate 1. In this way, the light source is emitted by passing through the optical fiber 2 and the light-emitting element 112, such that better effects in light focusing and illuminating can be obtained.

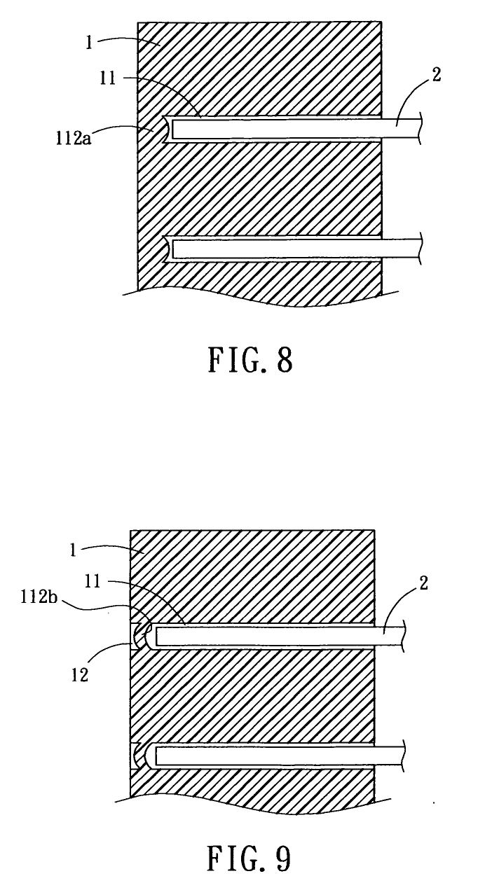

With reference to FIG. 8, a cross sectional view of the fourth embodiment of the present invention is shown. The light-emitting element 112 of the present invention is adapted not only to the above outward-projecting lens, but also to an inward-projecting lens. Similarly, the light source is emitted by passing through the optical fiber 2 and the light-emitting element 112a, such that better effects in light focusing and illuminating can be obtained.

With reference to FIG. 9, a cross sectional view of the fifth embodiment of the present invention is shown. One surface of the substrate 1 is provided with an accommodating region 11 therein. The other surface of the substrate is provided with a curved groove 12 corresponding to the light-focusing element 112b, such that the light-focusing element 112b is formed as an outward-projecting lens having two curved surfaces. Therefore, the light source is focused by passing through the optical fiber 2 and the light-emitting element 112b and emitted from the groove 12, such that much better effects in light focusing and illuminating can be obtained

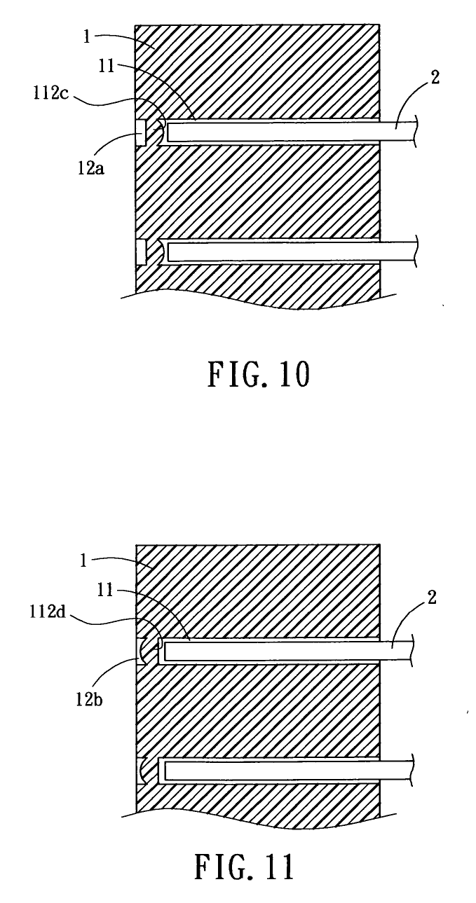

With reference to FIG. 10, a cross sectional view of the sixth embodiment of the present invention is shown. One surface of the substrate 1 is provided with an accommodating region 11 therein. The other surface of the substrate is provided with a plane-like groove 12a corresponding to the light-focusing element 112c, such that the light-focusing element 112c is formed as an inward-projecting lens. Therefore, the light source is focused by passing through the optical fiber 2 and the light-emitting element 112c and emitted from the groove 12a, such that much better effects in light focusing and illuminating can be obtained.

With reference to FIG. 11, a cross sectional view of the seventh embodiment of the present invention is shown. One surface of the substrate 1 is provided with an accommodating region 11 therein. The other surface of the substrate is provided with a plane-like groove 12b corresponding to the light-focusing element 112d, such that the light-focusing element 112d is formed as an outward-projecting lens. Therefore, the light source is focused by passing through the optical fiber 2 and the light-emitting element 112d and emitted from the groove 12b, such that much better effects in light focusing and illuminating can be obtained

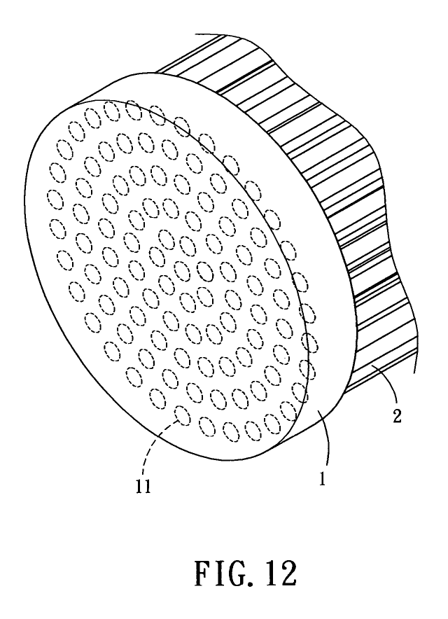

With reference to FIG. 12, a perspective view of the eighth embodiment of the present invention is shown. The structure of this embodiment is substantially identical to that of the fourth embodiment. The only difference lies in that the substrate shown in FIG. 4 is made as a square, whereas the substrate in this embodiment is made as a circle. Therefore, the user can have various choices in shape.

Although the present invention has been described with reference to the preferred embodiment thereof, it will be understood that the invention is not limited to the details thereof. Various equivalent variations and modifications can still be made in view of the teachings in the claims and specification of the present invention. Thus, all such variations and modifications are also embraced within the scope of the invention as defined in the appended claims.

What is claimed is:

1. An optical fiber array device, comprising a substrate for assembling the optical fiber array, wherein the substrate is provided with a plurality of accommodating regions, and one end of the accommodating region is provided with an opening communicating with the other surface of the substrate.

2. The optical fiber array structure according to claim 1, wherein the substrate is made of a transparent material, and the surface of the substrate is provided with a plane-like groove corresponding to the accommodating region.

3. An optical fiber array device comprising a substrate for assembling the optical fiber array, wherein the substrate is provided with a plurality of accommodating regions, one end of the accommodating region is provided with an opening communicating with the other surface of the substrate, and the other end of the accommodating region is provided with a light-focusing element in the substrate.

4. The optical fiber array structure according to claim 3, wherein the substrate is made of a transparent material, and the light-focusing element is an outward-projecting or inward-projecting lens.

5. The optical fiber array structure according to claim 3, wherein the surface of the substrate is provided with a plane-like groove corresponding to the light-focusing element, and the light-focusing element is an outward-projecting or inward-projecting lens.

6. An optical fiber array device comprising:
a substrate provided with a plurality of accommodating regions, wherein one end of the accommodating region is provided with an opening communicating with the other surface of the substrate, and the other end of the accommodating region is provided with a light-focusing element in the substrate; and
a plurality of optical fibers each provided in the accommodating region of the substrate, wherein the light-emitting face of each optical fiber corresponds to the light-focusing element of each accommodating region.

7. The optical fiber array structure according to claim 6, wherein the substrate is made of a transparent material, and the light-focusing element is an outward-projecting or inward-projecting lens.

8. The optical fiber array structure according to claim 6, wherein the surface of the substrate is provided with a curved groove corresponding to the light-focusing element, such that the light-focusing element is formed as an outward-projecting lens having two curved surfaces.

9. The optical fiber array structure according to claim 6, wherein the surface of the substrate is provided with a plane-like groove corresponding to the light-focusing element, such that the light-focusing element is formed as an inward-projecting lens.

10. The optical fiber array structure according to claim 6, wherein the surface of the substrate is provided with a plane-like groove corresponding to the light-focusing element, such that the light-focusing element is formed as an outward-projecting lens.
